(19) United States
(12) Patent Application Publication
(10) Pub. No.: US 2009/0017297 A1
(43) Pub. Date: Jan. 15, 2009

(54) IN-MOLD LABEL WITH FOAMED ADHESIVE SKIN

(76) Inventors: Moris Amon, Beachwood, OH (US); John E. Kovalchuk, Painesville, OH (US)

Correspondence Address: Heidi A. Boehlefeld, Esq.;RENNER, OTTO, BOISSELLE & SKLAR, LLP, 1621 Euclid Avenue, 19th Floor, Cleveland, OH, 44115, US

(21) Appl. No.: 11/576,692

(22) PCT Filed: Nov. 10, 2005
(86) PCT No.: PCT/US05/41081

§ 371 Date: Apr. 5, 2007

Related U.S. Application Data
(60) Provisional application No. 60/626,798, filed on Nov. 10, 2004.

(51) Int. Cl. B32B 33/00; B32B 27/00; B29C 65/02; B29C 44/04

(52) U.S. Cl. 428/349; 428/523; 264/241; 264/45.1

(57) ABSTRACT

An in-mold label film comprises a core layer and a heat seal layer wherein an inner surface of the heat seal layer overlies the core layer, wherein the heat seal layer is foamed and the outer surface of the heat seal layer is rough. The inventive film has performance advantages and is useful in an in-mold labeling process for labeling a plastic article such as a container.

This application claims the benefit of U. S. Provisional Application No. 60/626,798 filed Nov. 10, 2004, the contents of which are hereby incorporated by reference in their entirety.

### TECHNICAL FIELD

The present invention relates generally to in-mold label films for plastic substrates. In particular, the invention relates to in-mold label films that have a rough surface which provides improved performance in subsequent processing and in-mold label service to include, for example, air egress during the blow molding process.

### BACKGROUND

In-mold labeling has significant advantages over methods commonly used in the past to label plastic containers with polymeric labels. The most common of these previous methods involves the use of liner-carried pressure sensitive adhesive labels, or liner carried heat activatable adhesive labels. To produce the liner carried labels, a laminating step is performed to sandwich a layer of adhesive between a web of label stock and a web of silicone-coated paper which is to function as a carrier or release liner. The label stock is printed and the ink is dried by heating elements or ultraviolet radiation. Separate labels are cut from the label stock by passing the combination through a rotary-die or flat-bed cutting station. The matrix of waste or trim label stock surrounding the labels is stripped and discarded or recycled. Use of these types of methods results in high costs due to the use of a release liner, and the ecological difficulties in disposing of the liner and the trim.

In contrast, in-mold labeling avoids the use of any release liner or carrier. During in-mold labeling with polymeric labels, self-supported or free-film polymeric label stock is combined with heat-activatable adhesive, printed, die-cut and then arranged for deployment, as by being magazine-loaded as a series or stack of linerless labels, or by other means. The polymeric labels are then sequentially deployed on the molding surface of a blow mold to be bonded onto successive parisons of hot, melt plastic substrates. The parisons are expanded (blown) against the molding surface to produce a molded article such as, for example, a container, and the heat-activatable adhesive of the in-mold label activates and bonds (seals) to the blown plastic substrate.

When the in-mold label fails to form a bond with the plastic substrate at a particular site, a blister may form at the site. One of the main reasons for formation of the blister is that the heat seal layer did not activate completely or uniformly during the molding process. This can be due to inadequate venting of air locally trapped between parison and label. Another problem for in-mold labels is post-application blistering. This blistering occurs when the heat seal layer initially bonds to the plastic substrate but upon cooling, differential thermal shrinkage between substrate and label causes the bond to break. The activation temperature of the heat seal layer affects the ability of the in-mold label to effectively bond with the plastic substrate.

Further, a stack of labels under pressure from the tension springs of the in-mold label insertion equipment or by its own weight pushes out any air between the film labels. This increases the adhesion between the labels, causing the film labels to stick together, creating double picks and/or dropped labels during the placement process of the label in the mold.

It is desirable to obtain an in-mold label film which solves one or more of the above problems. Specifically, it is desirable to produce an in-mold label that reduces the amount of blistering and prevents double picks or dropped labels during the placement process.

The in-mold label films of the present invention eliminate or reduce at least some of these problems by providing a foamed layer having a rough surface. The rough surface provides for air egress during the blow molding process when the parison is blown against the label stock. Additionally, the rough surface reduces the adhesion between the individual labels, allowing them to be picked up with suction during the labeling process without double picks or dropped labels. A further advantage of the inventive film is improved sheet feeding due to the roughened surface during printing and die-cutting operations.

### SUMMARY

The present invention relates to an in-mold label film comprising a core layer and a heat seal layer, wherein the core layer has a first and second surface and the heat seal layer has an inner surface and an outer surface with the inner surface of the heat seal layer overlying the first surface of the core layer, wherein the heat seal layer comprises a foamed polymer having a rough outer surface. In one aspect of the invention, the heat seal layer comprises a polymer and a blowing agent.

In other aspects of the invention, a labeled plastic article comprises the above described in-mold label film.

In another aspect of the present invention, a process for in-mold labeling comprises providing an in-mold label film comprising a core layer and a heat seal layer, wherein the core layer has a first and second surface and the heat seal layer has an inner surface and an outer surface with the inner surface of the heat seal layer overlying the first surface of the core layer, wherein the heat seal layer is foamed and the outer surface of the heat seal layer is rough; inserting the film into a mold for producing a plastic substrate with an inside and outside surface; positioning and adhering the film to an interior molding surface of the mold by contacting the second surface of the core layer of the film with the internal molding surface of the mold; forming a labeled plastic article in the mold with sufficient heat to bond the heat seal layer of the film to the outside surface of the plastic article; cooling the labeled plastic article; and removing the labeled plastic article from the mold.

In a further embodiment of the invention, a labeled plastic article is prepared in accordance with the above described process for in-mold labeling. In another embodiment of the invention the label of this labeled plastic article is clear.

In an additional embodiment of the invention, a method to improve the blister and handleability performance of an in-mold label film comprises forming an in-mold label film wherein the film comprises a core layer and a heat seal layer, wherein the core layer has a first and second surface and the heat seal layer has an inner surface and an outer surface with the inner surface of the heat seal layer overlying the first surface of the core layer, wherein the heat seal layer is foamed and the outer surface of the heat seal layer is rough.

### BRIEF DESCRIPTION OF THE DRAWINGS

FIG. 1 is a cross-sectional view of an embodiment of an in-mold label film according to the present invention.

FIG. 2 is a cross-sectional view of another embodiment of an in-mold label film according to the present invention wherein the film includes a skin layer.

FIG. 3 is a cross-sectional view of yet another embodiment of an in-mold label film according to the present invention wherein the film includes at least one tie layer.

FIG. 4 is a representation of an embodiment of the method of preparing in-mold label films according to the present invention.

### DETAILED DESCRIPTION

The term “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer. The term “underlies” and cognate terms such as “underlying” and the like have similar meanings except that the first layer partially or completely lies under, rather than over, the second layer.

As described above, the in-mold label film comprises a heat seal layer overlying a core layer. The heat seal layer is foamed so that the outer surface, is a rough surface. The heat seal layer is activated by heat to form a bond with a plastic substrate. The heat seal layer can comprise a polymer and a blowing agent.

The heat seal layer of this invention can be foamed by incorporating or including a blowing agent into the heat seal layer composition. The incorporated blowing agent can create or produce a foamed heat seal layer having a rough outer surface. The blowing agent can comprise a physical blowing agent, a chemical blowing agent, or a combination of any of the foregoing blowing agents. The combination of blowing agents can comprise two or more physical blowing agents, two or more chemical blowing agents, or one or more physical blowing agents with one or more chemical blowing agents. Physical blowing agents undergo only a physical change. Physical blowing agents can comprise compressed gases, volatile liquids, or a combination thereof. Compressed gases can comprise compressed nitrogen, compressed air, compressed carbon dioxide, or a combination of any of the foregoing compressed gases. Volatile liquids can comprise low boiling solvents which can comprise hydrocarbons including aliphatic hydrocarbons and/or aromatic hydrocarbons, halogen-containing hydrocarbons including halogen-containing aliphatic hydrocarbons and/or halogen-containing aromatic hydrocarbons, or combinations of any of the foregoing solvents. In one embodiment of the invention, the physical blowing agent can comprise compressed nitrogen, compressed air, compressed carbon dioxide, a hydrocarbon, a halogen-containing hydrocarbon, or a combination of any of the foregoing physical blowing agents. The low boiling solvent can include organic carbon-based compounds, more particularly halocarbons, such as chlorofluorocarbons (CFC's), hydrohalocarbons such as hydrochlorofluorocarbons (HCFC's), hydrochlorocarbons (HCC's), hydrofluorocarbons (HFC's), and the like.

Physical blowing agents can include aliphatic hydrocarbons having 1-9 carbon atoms and fully and partially halogenated aliphatic hydrocarbons having 1-4 carbon atoms. Aliphatic hydrocarbons include methane, ethane, propane, n-butane, isobutane, n-pentane, isopentane, neopentane, ethanol, and dimethyl ether. Fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane, 1,1,1-trifluoroethane (HFC-143a), 1,1,1,2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Partially halogenated chlorocarbons and chlorofluorocarbons include methyl chloride, methylene chloride, ethyl chloride, 1,1,1-trichloroehtnae, 1,1-dichloro-1-fluoroethane (FCFC-141b), 1-chloro-1,1-difluoroethane (HCFC-142b), 1,1-dichloro-2,2,2-trifluoroethane (HCHC-123) and 1-chloro-1,2,2,2-tetrafluoroethane (HCFC-124). Fully halogenated chlorofluorocarbons include trichloromonofluoromethane (CFC-11) dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Typically, the physical blowing agent comprises a partially halogenated chlorofluorocarbon. Mixtures of the physical blowing agent and water can also be used. In this case, the ratio of water to physical blowing agent typically is such that the finished molded part still has a self-skin, durable top layer. When physical blowing agents are used in foaming, the gas phase of the foam is chemically identical with the blowing agent.

Chemical blowing agents can comprise compositions that are normally in the solid state at ambient temperatures and that are stable at normal storage temperatures and under specific processing conditions, but react or decompose at elevated temperatures, such as those employed in extrusion, to give one or more decomposition products where at least one of the decomposition products is normally a gas at atmospheric pressure. This gas is normally soluble or miscible to some extent in a softened polymer or polymer melt at high pressure, but will come out of solution and form bubbles or foam in the melt upon release of the pressure. The chemical blowing agent can comprise an exothermic blowing agent, an endothermic blowing agent, or a combination thereof. The combination of chemical blowing agents can comprise two or more endothermic blowing agents, two or more exothermic blowing agents, or one or more endothermic blowing agents with one or more exothermic blowing agents. The chemical blowing agent can further comprise a resin or polymer where the polymer can serve as a convenient matrix for introducing or incorporating the exothermic and/or endothermic blowing agent into a heat seal layer. The chemical blowing agent can comprise one or more polymers. The one or more polymers can comprise one or more thermoplastic polymers. The thermoplastic polymer can comprise a polyolefin which can be prepared from alkenes having 2-30 carbon atoms where the polyolefin can comprise a homopolymer and/or copolymer from two or more alkene monomers such as, for example, a polypropylene homopolymer or a linear low density polyethylene; a poly(alkyl (meth)acrylate) which can comprise a poly(alkyl methacrylate) such as, for example, a poly(ethyl methacrylate), a poly(alkyl acrylate), a copolymer of an alkyl methacrylate and an alkyl acrylate, or mixtures thereof; a styrene-based homopolymer or copolymer; a halocarbon polymer such as a poly(vinyl chloride); a polyamide; a polyurethane; an alkene-vinyl carboxylate copolymer such as, e. g., an ethylene-vinyl acetate copolymer; an acrylonitrile-based homopolymer or copolymer; a cyclic olefin homopolymer or copolymer; an ionomer comprising a metal-containing salt of an alkene-(meth)acrylic acid copolymer; a polyester, or a combination of any of the foregoing thermoplastic polymers. The chemical blowing agent can comprise an exothermic blowing agent and/or endothermic blowing agent. Exothermic blowing agents generally can comprise solid organic materials which decompose at an elevated temperature with the release of energy/heat and primarily generate nitrogen as the major gas. Exothermic blowing agents can comprise hydrazine derivatives such as, for example, azodicarbonamide. Endothermic blowing agents generally can comprise solid organic and/or inorganic materials which decompose at an elevated temperature with the absorption of energy/heat and primarily generate carbon dioxide as the major gas. Endothermic blowing agents can comprise carbonate salts such as, e. g., ammonium carbonate, bicarbonate salts such as, e. g., sodium bicarbonate, metal borohydrides such as, e. g., sodium borohydride, carbamate salts such as, ammonium carbamate, carboxylate salts such as, e. g., ammonium acetate, polycarboxylic acids such as e. g. citric acid, or a combination of any of the foregoing endothermic blowing agents.

In one embodiment of the invention, the heat seal layer can comprise a chemical blowing agent comprising an endothermic blowing agent and a polymer, and in another embodiment of the invention the polymer can comprise a polyethylene, a polypropylene, a poly(alkyl (meth)acrylate), or a combination of any of the foregoing polymers. In one embodiment of the invention, the exothermic or endothermic blowing agent can be present in the heat seal layer on a weight basis at 10-100,000 ppm (parts per million), 50-50,000 ppm, or 100-30,000 ppm. The blowing agent can foam the outer surface of the heat seal layer so that the outer surface is rough. In several embodiments of the invention the outer surface of the foamed heat seal layer has a Sheffield roughness according to air leak methods ISO 2494 or TAPPI 538 (in ml per minute) of 0.5-2,000, 5-1,500, or 10-1,000.

Useful chemical blowing agents are available commercially from A. Schulman Inc. of Akron, Ohio under the following product names: XU1515, U0294L and P2635 08AA. The P2635 08M product is a blowing agent containing a 2.5% endothermic blowing agent based in a polypropylene homopolymer, which produces CO₂ gas for foaming. The U0294L product is a blowing agent containing a 20% endothermic blowing agent based in a 0.925 density linear low density polyethylene, which produces CO₂ gas for foaming. The XU1515 product is a blowing agent containing a 30% endothermic blowing agent in a poly(ethyl methacrylate) base, which produces CO₂ gas for foaming.

One or more polymers can be present in the heat seal layer at a level from about 30% to about 100%, or from about 30% to about 90%, or from about 35% to about 85% by weight. In one embodiment, the one or more polymers can be present in an amount from about 40% up to about 99%, or from about 50% to about 95%, or from about 60% up to about 90% by weight. In another embodiment, the one or more polymers can be present in an amount from about 20% up to about 70% or from about 25% to about 60%, or from about 30% up to about 50% by weight.

The heat seal layer can comprise one or more polymers. These one or more polymers can comprise one or more thermoplastic polymers as described hereinabove that can be present in the chemical blowing agent. The heat seal layer can comprise one or more thermoplastic polymers comprising a polyolefin, a poly(alkyl (meth)acrylate), a styrene-based homopolymer or copolymer, a halocarbon polymer, a polyamide, a polyurethane, an alkene-vinyl carboxylate copolymer, an acrylonitrile-based homopolymer or copolymer, a cyclic olefin homopolymer or copolymer, an ionomer, a polyester, or a combination of any of the foregoing thermoplastic polymers. The heat seal layer can comprise one or more polyolefins. The polyolefin can comprise a homopolymer, or a copolymer. The olefins that may be used to prepare the polyolefins include those having from two to thirty, or two to about ten, or from two to about eight, or from about two to about four carbon atoms. Examples of useful olefins include ethylene, propylene, butylene, methyl-pentene, hexene, octene, etc. In one embodiment, the polyolefin comprises a homopolymer or copolymer derived of ethylene, propylene or butylene. In another embodiment, the polyolefin can comprise a polyethylene homopolymer, or a polyethylene. The copolymer may be prepared from ethylene, propylene, or butylene and an olefin having from about 3 to about 100 or from about 4 to about 30 carbon atoms. In one embodiment, the olefin has from about three to about twelve, or from about four to about ten carbon atoms. In another embodiment, the olefin has from about 10 to about 100, or from about 12 to about 30 carbon atoms. In one embodiment, the olefin used to prepare the copolymer comprises an alpha-olefin. Examples of useful olefins include propylene, butylene, pentene, 4-methyl-1-pentene, hexene, heptene, octene, nonene, decene, undecene, dodecene, tetradecene, hexadecene, octadecene, and docosene. Typically, the olefin is present in an amount from about 1% up to about 50%, or from about 5% to about 30%, or from about 7% up to about 25% by mole. Examples of copolymers of ethylene include ethylene/propylene copolymers, ethylene/butylene copolymers, ethylene/hexene copolymers, ethylene/octene copolymers and ethylene/dodecene copolymers. Copolymers of ethylene and olefins, such as alpha-olefins, and processes for preparing them are disclosed in U.S. Pat. No. 5,475,075, issued to Brant et al, and U.S. Pat. No. 5,530,054, issued to Tse et al.

In another embodiment, the heat seal layer may contain a blend of (i) a polyolefin and (ii) one or more film-forming polymers. Examples of film-forming polymers include polyolefins other than (i), polystyrene, ethylene-acrylic acid copolymer, ethylene-methacryiic acid copolymer, ethylene-acrylate ester copolymer, ethylene-methacrylate ester copolymer, ethylene-vinyl alcohol copolymer, ethylene-vinyl acetate copolymer, ethylene-vinyl chloride copolymer, polycarbonate, styrene-maleic anhydride copolymer, styrene-acrylonitrile copolymer, acrylonitrile-butadiene-styrene copolymer, nylon, polyurethane, polysulfone, poly(vinylidene chloride), ionomers based on alkali metal or zinc salts of ethylene-methacrylic acid copolymers, polyacrylates, polymethacrylates, cellulosics, fluoroplastics, polyacrylonitriles, thermal polyesters and mixtures of two or more thereof. Further examples of the polymer (ii) can include ethylene-ethyl acrylate copolymer, ethylene-methyl acrylate copolymer, poly(vinyl chloride), poly(4-methyl-1-pentene), poly(methyl methacrylates), polybutylene terephthalate (PBT), polyethylene terephthalate (PET), thermoplastic polyesters and mixtures of two or more thereof. The blend may contain from about 1% to 80%, or from about 5% to about 75%, or from about 10% to about 60% by weight of the additional polymers. In another embodiment of the invention, the heat seal layer can comprise at least one polyethylene (PE) and an ethylene-vinyl acetate copolymer. This polyethylene can be a very low density PE, a low density PE, a medium density PE, a linear low density PE, a high density PE, or a combination of any of the foregoing polyethylenes.

Examples of the commercially available polymers or thermoplastic polymers useful in this invention include ethylene-vinyl acetate (EVA) copolymers containing about 9-25% by weight vinyl acetate such as those available from AT Plastics to include ATEVA 1231 which is an ethylene-vinyl acetate (EVA) copolymer containing 12% vinyl acetate, having a melt index of 3.0 g/10 min., a melt temperature of 97° C. and a density of 0.934 g/cc; Dow Affinity—KC8852, which is an ethylene/octene copolymer containing a melt index of 3.0 g/10 min., a melt temperature of 68° C. and a density of 0.875 g/cc; Exxon Exact 8203, which is an ethylene/octene copolymer containing a melt index of 3.0 g/10 min., a melt temperature of 73° C. and a density of 0.882 g/cc; or Exxon Exact 4151, which is an ethylene based plastomer having a melt index of 2.2 g/10 min., a melt temperature of 890C and a density of 0.895 g/cc.

Various polyethylenes, polypropylenes and polybutylenes can be utilized in the core, skin and heat seal layers of the inventive in-mold label film including very low density and/or low density and/or medium density and/or linear low density and/or high density polyethylenes, polypropylenes, polybutylenes, and mixtures thereof. An example of a useful high density polyethylene (HDPE) is Huntsman—H2105, which contains a melt flow index of 8.0 g/l 0 min. and a density of 0.963 g/cc.

The heat seal layer may also contain an antiblock and/or an antistatic additive. The antiblock additives include natural silica, diatomaceous earth, synthetic silica, glass spheres, ceramic particles, etc. The antiblock additive may be added as a concentrate. An example of an antiblock concentrate is manufactured by A. Schulman Inc. of Akron, Ohio under the product name Polybatch AB5. The Polybatch AB5 is an antiblock concentrate containing 5 weight percent amorphous silica based in 95% low density polyethylene, and is designed for use in polyethylene applications. The Polybatch AB5 material has the following material properties (which are based on its technical data sheet): melt index of concentrate of 17+/−3 grams/10 minutes; ash (percent amorphous silica) of 5+/−2 percent; moisture retention (Karl Fischer@ 190° C.) of 1000 ppm maximum; and pellets per gram of 45+/−5. When the antiblock is present the antiblock is present in an amount from about 10,000 to about 60,000, or from about 20,000 to about 50,000, or from about 40,000 ppm.

The antistatic additives include an amine or an amide or a derivative of a fatty acid. The antistatic is incorporated in the adhesive-containing or base layer charge and uniformly blended therewith. The amount of antistatic used may be varied for particular formulations and processing conditions. Typically from about 0.5% to about 15%, or from about 2% to about 10%, or about 2% by weight of the antistatic additive is used. An example of an antistatic additive is an antistatic concentrate manufactured by A. Schulman Inc. of Akron, Ohio and sold under the product name Polybatch VLA-55-SF. Polybatch VLA-55-SF is a specialty antistatic concentrate. The Polybatch VLA-55-SF material has the following material properties: melt index of the concentrate of 11-18 grams/10 minutes; and moisture retention (Karl Fischer 0 190° C.) of 1000 ppm minimum.

The heat seal layer is designed for and activated at temperatures known to those skilled in the art. While the heat seal layer may activate at temperatures below those specified for activation, the heat seal layer is designed to activate at certain temperatures based on the substrate material under normal in-mold labeling conditions. In several embodiments of the invention, the heat seal layer activates in the temperature range of 50-130° C. or 60-115° C. or at temperatures between about 54 to about 100° C., about 57 to about 80° C., or about 62 to about 70° C.

The in-mold label film of the present invention comprises a core layer. The core layer may be a single layer or a multilayer structure. The core layer can comprise one or more polymers. These one or more polymers can comprise one or more thermoplastic polymers as described hereinabove with reference to the chemical blowing agent and the heat seal layer. In one embodiment, the core layer can comprise a polyolefin to include a very low density and/or a low density and/or a medium density and/or a linear low density and/or a high density polyethylene, a polypropylene, a polybutylene, a copolymer of ethylene and/or of propylene and/or of butylene with an olefin, or mixtures thereof. The polyolefin may be prepared using a metallocene catalyst. The polyolefin may be prepared from a copolymer of propylene and an alpha olefin, such as those containing from about two to about ten carbon atoms, and including ethylene, butylene, hexene and octene. The polyolefin can comprise a polypropylene homopolymer such as, e. g., a polypropylene homopolymer sold by Huntsman Corporation of Houston, Tex., under the product number P4G3Z-050. The P4G3Z-050 product has a melt flow index of 3.5 grams/10 minutes and a density of 0.90 g/cc. The polyolefin can comprise a random propylene copolymer which can have from 3 to about 5% by weight ethylene comonomer. The polyolefin can comprise a nucleated random polypropylene copolymer such as, e. g., a copolymer which is sold by Huntsman Corporation of Houston, Tex., under the product name P5M4K-070X. The P5M4K-070X nucleated random copolymer contains 3.2% ethylene comonomer and has a phenolic based antioxidant package.

The core layer may include a titanium dioxide concentrate. The titanium dioxide concentrate is a blend of 50% polypropylene homopolymer and 50% titanium dioxide by weight. The concentrate is available in pellet form for convenience of addition to the extrusion feed. Typically the core layer comprises about 40% to about 100%, or from about 50% to about 90%, or from about 60% to about 80% of polyolefin, such as random polypropylene copolymer. In one embodiment, the titanium concentrate is present in an amount from about 2% to about 30%, or from about 5% to about 25%, or from about 10% to about 20% by weight of the core layer. An example of a titanium dioxide concentrate is commercially available from A. Schulman Inc. Akron, Ohio under the product name Polybatch P8555-SD. The Polybatch P8555-SD product contains 50% TiO₂ in polypropylene.

In another embodiment, the core layer may include a calcium carbonate concentrate. The calcium carbonate concentrate may be used with a polyolefin homopolymer, such as a polypropylene homopolymer. The calcium carbonate concentrate may be present in an amount from about 30% to about 85%, or from about 40% to about 80%, or from about 50% to about 70% by weight of the core layer. An example of a calcium carbonate concentrate is composed of polypropylene with 40 weight percent calcium carbonate mineral filler, the material has a melt index of 3.0 minimum to 6.0 maximum (ASTM D1238); ash of 40.0+/−2.0%, volatiles of 500 ppm max.; and a bulk density of 730+/−50 g/l. The useful calcium carbonate concentrate is sold by A. Schulman Inc. of Akron, Ohio under the product name Polybatch PF92D.

The inventive film can comprise a printable skin layer. In one embodiment of the invention a printable skin layer overlies a second surface of a core layer while a heat seal layer overlies a first surface of the core layer. The skin layer can comprise one or more thermoplastic polymers as described hereinabove with reference to the chemical blowing agent and heat seal layer. The skin or print layer may be developed for its appearance and printing characteristics. Materials for the skin or print layer for in-mold labels include but are not limited to the following film forming materials used alone or in combination such as polyethylene, metallocene catalyzed polyolefins, syndiotactic polystyrene, syndiotactic polypropylene, cyclic polyolefins, polyethylene methyl acrylic acid, polyethylene ethyl acrylate, polyethylene methyl acrylate, acrylonitrile butadiene styrene polymer, polyethylene vinyl alcohol, polyethylene vinyl acetate, ethylene vinyl acetate, nylon, polyethylene, polybutylene, polystyrene, polyurethane, polysulfone, polyvinylidene chloride, polypropylene, homopolypropylene, polycarbonate, polymethyl pentene, styrene maleic anhydride polymer, styrene acrylonitrile polymer, ionomers based on sodium or zinc salts of ethylene/methacrylic acid, polymethyl methacrylates, cellulosics, fluoroplastics, polyacrylonitriles, and thermoplastic polyesters. In one embodiment, homopolypropylene is used in the skin layer (or layers). In one embodiment, a mixture of ethylene vinyl acetate copolymer/homopolypropylene is used. An example of a homopolypropylene is Huntsman P4G4K-173X. The P4G4K-173X product is a nucleated homopolypropylene which has a melt index of 3.5 g/10 min. An example of an EVA copolymer is AT Plastics—Ateva 1821. The Ateva 1821 product is an EVA copolymer which has an 18% vinyl acetate content, a melt index of 3.0 g/10 min. and a density of 0.938 g/cc.

The label film of the present invention may also contain one or more tie layers. The tie layers may be positioned between the core layer and the heat seal layer and/or between the core layer and the skin layer. The tie layers may be comprised of thermoplastic polymeric materials such as polypropylene, copolymers of ethylene and propylene, homopolypropylene, or titanium dioxide concentrate and/or calcium carbonate concentrate. An example of a homopolypropylene is Huntsman P4G3Z-050 which has a melt index of 11.0 g/10 min. An example of a titanium dioxide concentrate is A. Schulman Inc. Polybatch P8555-SD which contains 50% TiO₂ in polypropylene. An example of a calcium carbonate concentrate is A. Schulman Inc. Polybatch PF92D which contains 40% CaCO₃ in polypropylene.

The film can be manufactured by those processes known to those in the art such as casting, coating or extrusion. U.S. Pat. No. 5,186,782, issued to Freedman, and U.S. Pat. Nos. 5,242,650 and 5,435,963, both issued to Rackovan et al disclose films, labels and processes for making the same. The films may be manufactured by a polymer extrusion or coextrusion process. In one embodiment, the extrudate or coextrudate of polymeric film materials is formed by simultaneous extrusion from a suitable known type of extrusion or coextrusion die, and in the case of the coextrudate the layers are adhered to each other in a permanently combined state to provide a unitary coextrudate. A tie layer can be used when the materials of the layer (or layers) of the core, or materials of the core and the skin layer (or layers) do not sufficiently adhere or bond to each other when they are extruded together. In one embodiment, the multilayer film is coextruded. Care, however, should be taken to prevent activation of the heat seal layer during the film manufacturing process.

The cast or extruded or coextruded film comprising at least one or more layers to include a heat seal layer and/or a core layer and/or a printable skin layer can be either biaxially or uniaxially oriented. The means for orienting the film includes, but is not limited to, cold stretching, hot stretching, compression rolling, hot compression rolling, and a blown extrusion process. In one embodiment, the film is uniaxially oriented and the material may be hot stretched. In embodiments of the invention the oriented film can be annealed. If the film will have an application with further processing or service temperatures above room temperature, the film may also be heat set or annealed to provide for dimensional stability, i.e. to prevent shrinking, relaxing or any distortion of the film. In one embodiment, the film thickness is less than about 10 mils, or less than about 7 mils, or the film thickness is from about 2 mil to about 6 mil., or the film thickness is from about 3 mil to about 5 mil.

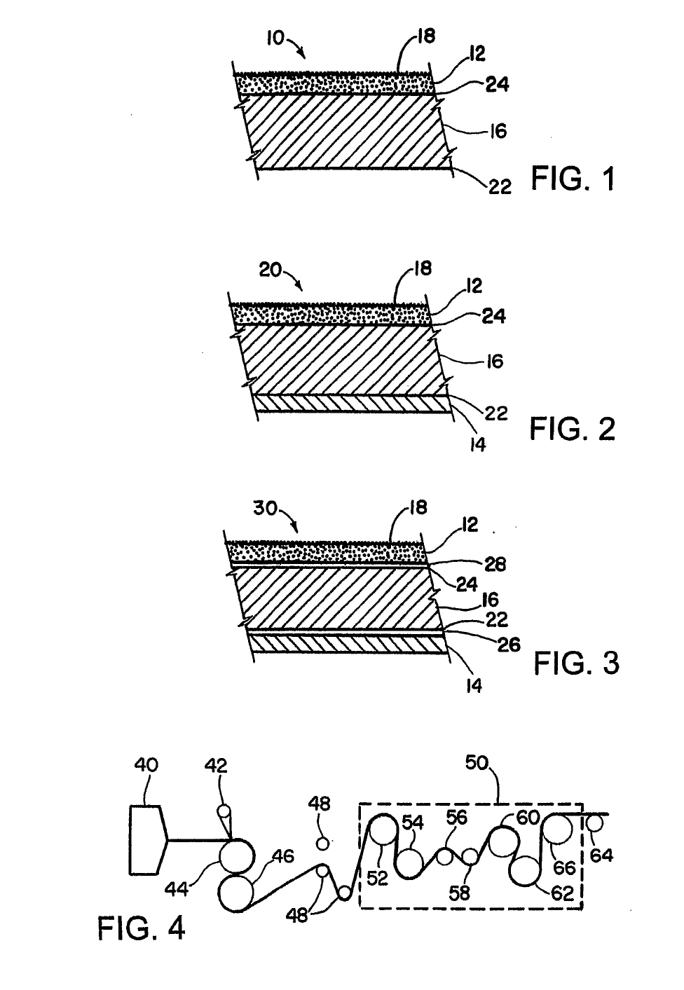

In one of the embodiments, the film 10 shown in FIG. 1 is a coextrudate comprising a core layer 16, which has a first surface 24 and a second surface 22 and a heat seal layer 12 overlying the first surface 24 of the core layer 16. The heat seal layer 12 comprises a foamed polymer having a rough outer surface 18. In another embodiment, the film 20 shown in FIG. 2 comprises a core layer 16, a heat seal layer 12 overlying the first surface 24 of the core layer 16, and a skin layer 14 underlying the second surface 22 of the core layer 16. The heat seal layer 12 comprises a foamed polymer having a rough outer surface 18. In another embodiment, the film 30 shown in FIG. 3 comprises a core layer 16, a heat seal layer 12 overlying the first surface 24 of the core layer 16, and a skin layer 14 underlying the second surface 22 of the core layer 16. The heat seal layer 12 comprises a foamed polymer having a rough outer surface 18. The layers 28 and 26 are positioned, respectively in between the core layer 16 and heat seal layer 12 and between the core layer 16 and the skin layer 14. The charges for the several layers are prepared for extrusion through the multifeed coextrusion die 40 as illustrated in FIG. 4.

In the embodiment of FIG. 4 an extrusion or coextrusion is performed at a temperature above the softening or melting temperature of the polymer components of the film. The extrusion or coextrusion die may be maintained in a range of 200-260° C. or between about 200° C. and about 230° C. This temperature is high enough to activate a blowing agent in the adhesive skin or heat seal layer, and generate a gas. Because of the high pressure in the die (typically 500 psi or more) the gas remains dissolved in the polymer melt. The dissolved gas in the adhesive skin or heat seal layer comes out of solution as soon as the coextrudate exits the die, and forms numerous microscopic bubbles in this layer. These bubbles either protrude or burst open through the outer surface of the adhesive skin or heat seal layer, thereby roughening it.

The extruded film is cast onto a casting roll 44 which may be maintained between about 20° C. and about 50° C., and is provided with an air knife 42. The pressure of the air from the air knife presses the cast film or sheet against the casting roll, thereby ensuring uniform cooling of the sheet. The combined action of casting roll and air knife tends to smooth the surface of the sheet in contact with this roll. Thus the rough outer surface of heat seal layer should not be placed against the casting roll.

The film continues around the casting roll 44 and then passes to the chill roll 46 which may be maintained from about 20° C. to about 70° C., or at about 66° C. The film continues around the chill roll, trains through the rolls 48, and enters the uniaxial (or machine) direction orientation unit (MDO) 50.

Within the MDO unit, the film is stretched and stiffened in the machine direction. The film is passed around a first pre-heat roll 52 and then around a second pre-heat roll 54. These rolls are maintained at between from about 90° C. to about 120° C., or about 110° C., and from about 60° C. to about 100° C., or about 80° C., respectively. After leaving the second pre-heat roll the film tracks on the slow draw roll 56, may be maintained at a temperature from about 80° C. to about 120° C., or about 100° C. The film is then pulled to the fast draw roll 58, maintained at about 75° C. to about 105° C., or about 85° C. In this embodiment, the film is stretched sixfold and is drawn down to about 20% of its original thickness. In general, stretch ratios may be from about 2:1 to 10:1, about 4:1 to about 10:1, or from about 4:1 to about 6:1.

As the film leaves the pull-roll pair 56, 58, the stretched film may be subject to severe shrinkage if it is heated while under little or no mechanical constraint. The polymer film is said to have a “memory” of its original length to which it tends to return when heated. The film may be annealed to remove this tendency by applying heat to the tensioned film at the annealing rolls 60 and 62. Roll 60, in this embodiment, is maintained between from about 115° C. to about 140° C. or at about 127° C. The roll 62 may be maintained at a temperature between from about 65° C. to about 120° C., or at about 85° C. The film then passes directly to the chill roll 66, which may be maintained at a temperature from about 20° C. to about 40° C., or ambient temperature.

After leaving the chill roll 66 at the completion of the hot stretch operation, the film may be taken up as a self-wound roll 64. The roll 64 may be conveniently transported and stored.

The heat seal layer may be coated onto the core by conventional coating processes or may be coextruded with the film in the form of a heat seal layer. Typically, the heat seal layer is tailored to be heat sensitive. The film material may be printed, and then die or laser cut. The printed and cut label is placed inside the mold cavity during the molding process for producing a plastic article or container with the adhesive side or heat seal layer facing the outside surface of the hot plastic container. As the plastic is molded, the heat activates or melts the adhesive or heat seal layer on the label film, and the label film and the plastic article or container form a permanent bond.

In one embodiment of the invention a labeled plastic article comprises the inventive in-mold label film described throughout this application. The labeled plastic article can be formed in an in-mold labeling process that comprises the film.

The present invention further includes a process for in-mold labeling comprising providing an in-mold label film comprising a core layer and a heat seal layer, wherein the core layer has a first and second surface and the heat seal layer has an inner surface and an outer surface with the inner surface of the heat seal layer overlying the first surface of the core layer, wherein the heat seal layer is foamed and the outer surface of the heat seal layer is rough; inserting the film into a mold for producing a plastic substrate with an inside and outside surface; positioning and adhering the film to an interior molding surface of the mold by contacting the second surface of the core layer of the film with the internal molding surface of the mold; forming a labeled plastic article in the mold with sufficient heat to bond the heat seal layer of the film to the outside surface of the plastic article; cooling the labeled plastic article; and removing the labeled plastic article from the mold. In another embodiment of the invention where the film further comprises a printable skin layer overlying the second surface of the core layer, the film can be positioned in the mold so that the printable skin layer contacts the internal molding surface of the mold.

In an additional embodiment of the invention, a labeled plastic article is prepared in accordance with the above described in-mold labeling process. During the in-mold labeling process the foamed (bubbled) or rough surface of the heat seal layer provides for improved handleability of the film or label during insertion into the mold by increasing the amount of air between successive films or labels in a label stack so that the labels are readily separated and can be picked up one at a time for insertion in the mold. The foamed or rough surface of the heat seal layer additionally provides for reduced blistering of the film during the formation of the molded labeled article by providing for air egress at the moment of contact between the parison and the label film. In one embodiment of the invention, the rough surface of the film has an additional utility of increasing the opacity of a label on a labeled article when lower temperature and pressure conditions are selected inside the mold after contact of the parison and label film to leave the foamed layer partially to fully intact. In another embodiment of the invention, the label of the labeled article is clear when higher temperature and pressure conditions are selected inside the mold to press out the bubbles of the foamed layer.

A method to improve the blister and handleability performance of an in-mold label film comprises forming an in-mold label film wherein the film comprises a core layer and a heat seal layer, wherein the core layer has a first and second surface and the heat seal layer has an inner surface and an outer surface with the inner surface of the heat seal layer overlying the first surface of the core layer, wherein the heat seal layer is foamed and the outer surface of the heat seal layer is rough. This inventive method reduces blistering of a labeled plastic article and improves handleability of the film by reducing or eliminating dropped or double/multiple picks of the film during placement steps where the film is used in an in-mold labeling process to prepare the labeled plastic article as described herein.

### EXAMPLES

In order that persons in the art may better understand the practice of the present invention, the following Examples are provided by way of illustration, and not by way of limitation. Additional background information known in the art may be found in the references and patents cited herein.

These examples are samples of film typically used as in-mold labels. For in-mold labeling this film would typically be converted into labels for application onto plastic containers during the process of forming these containers. Table 1 contains examples of formulations useful as heat seal layers. Table 2 contains examples of formulations useful as core layers. Table 3 contains examples of formulations useful as skin layers. Table 4 contains examples of formulations useful as tie layers. Table 5 contains example films produced by combining the formulations from Tables 1-4. Table 6 contains the properties of the example films of Table 5.

Table 1 shows the composition of the heat seal layer by weight percent of components. The EVA copolymer is AT Plastics—ATEVA 1231, which has 12% vinyl acetate, a melt index of 3.0 g/10 min. and a melt temperature of 97° C. The ethylene/octene copolymer is either Dow Affinity—KC8852, which has a melt index of 3.0 g/10 min., a melt temperature of 68° C. and a density of 0.875 g/cc; or Exxon Exact 8203, which has a melt index of 3.0 g/10 min., a melt temperature of 73° C. and a density of 0.882 g/cc. The ethylene-octene copolymer may also be replaced with an ethylene based plastomer, such as Exxon Exact 4151, which has a melt index of 2.2 g/10 min., a melt temperature of 89° C. and a density of 0.895 g/cc. HDPE is a high density polyethylene sold by Huntsman Corporation of Houston, Tex., under the product number H2105. The H2105 product has the following characteristics: a melt flow index of 8.0 g/10 min. and a density of 0.963 g/cc. LDPE is a low density polyethylene sold by A. Schulman Inc. of Akron, Ohio under the product name XABVT-1205. The XABVT-1205 product is a 12 micron “Tospearl” in LDPE, which functions as an antiblock/slip additive.

The antiblock concentrate is manufactured by A. Schulman Inc. of Akron, Ohio under the product name Polybatch AB5 antiblock. The Polybatch AB5 is an antiblock concentrate containing 5 weight percent amorphous silica based in 95% low density polyethylene, and is designed for use in polyethylene applications. The Polybatch AB5 material has the following material properties: melt index of concentrate of 17+/−3 grams/10 minutes; ash (percent amorphous silica) of 5+/−2 percent; moisture retention (Karl Fischer @ 190° C.) of 1000 ppm maximum; and pellets per gram of 45+/−5. A process aid may be used in place of the antiblock concentrate. The process aid is Ampacet 10919 Process Aid, which contains a 3% Dynamar process aid based in low density polyethylene. The antistatic concentrate is also manufactured by A. Schulman Inc. of Akron, Ohio under the product name Polybatch VLA 55 SF. Polybatch VLA 55 SF material has the following material properties: melt index of the concentrate of 11-18 grams/10 minutes; and moisture retention (Karl Fischer 0 190° C.) of 1000 ppm minimum.

The blowing agents are also manufactured by A. Schulman Inc. of Akron, Ohio under the following product names: XU1515, U0294L and P2635 08AA. The P2635 08AA product is a blowing agent containing a 2.5% endothermic blowing agent based in a homo-polypropylene, which produces CO₂ gas for foaming. The U0294L product is a blowing agent containing a 20% endothermic blowing agent based in a 0.925 density linear low density polyethylene, which produces CO₂ gas for foaming. The XU1515 product is a blowing agent containing a 30% endothermic blowing agent in an ethyl methacrylate base, which produces CO₂ gas for foaming.

The materials for the heat seal layer are melted and mixed in a 2½ inch extruder manufactured by Davis Standard of Pawcatuck, Conn. with an extruder barrel length (L) to extruder barrel inner diameter (D) or UD ratio of 24:1. The extruder contains six temperature zones which were maintained at 177, 205, 216, 222, 222, and 224° C., respectively.

The printable skin layers of the three layer film are melted and mixed in a 2½ inch extruder with a L/D ratio of 24:1. This extruder is manufactured by Davis Standard of Pawcatuck, Conn. The extruder contains six temperature zones which where are maintained during melting and mixing at 177, 205, 222, 222, 227, and 227° C., respectively.

The cores of the films are melted and mixed in a 130 mm extruder with a L/D ratio of 34:1. This extruder was manufactured by Davis Standard of Pawcatuck, Conn. The extruder contains eight temperature zones which are maintained during melting and mixing at 196, 199, 202, 207, 210, 213, 216, and 227° C., respectively. The calcium carbonate of the core material is dried prior to mixing in an oven manufactured by Conair Franklin of Franklin, Pa. at 80° C. for four hours to insure that the concentrate material contains little or no moisture.

The three extruders feed a multilayer feedblock with a coathanger die. Both the feedblock, die and adapter pieces which connect the extruders, feedblock and die together are held at a constant temperature of 218° C. The three layer films are extruded onto a casting roll which is maintained at 30° C., and are provided with an air knife for further cooling the film and followed by a second cooling roll at 66° C. The film is then stretched uniaxially in the machine direction by being run through an orientation unit which orients the film in the machine direction (MD). The orientation unit consists of a number of rolls the first two of which are used for pre-heating the film prior to stretching. These rolls are maintained at 110° C. and 80° C., respectively so that a substantial portion of the thickness of the film is heated. The film is stretched between the slow draw roll, maintained at 100° C. (moving the film at 30 feet/minute) and a fast draw roll, maintained at 80° C., (moving the film at 180 feet/minute). All of the samples are stretched or drawn down to approximately 4 mils which is approximately 20 percent of the original thickness of the film as it is extruded onto the casting roll. The stretched uniaxially oriented film is then cured (or annealed) by applying heat to the tensioned film stock at an annealing station with two rolls. The annealing rolls are maintained at a temperature of 127° C. and 85° C., respectively. The film is then passed onto a chill roll maintained at a temperature of 20° C.

TABLE 1
HEAT SEAL LAYER

| | | Ethylene/ | | | Blowing | | |
|---|---|---|---|---|---|---|---|
| Example | EVA¹ | Octene² | Antiblock³ | Antistatic⁴ | Agent⁵ | HDPE⁶ | LDPE⁷ |
| H1 | 45 | 49.5 - Dow | 2.5 - | 2.0 | 1.0 - | — | — |
| | | KC8852 | Polybatch | | P2635- | | |
| | | | AB5 | | 08AA | | |
| H2 | 44 | 49.5 - Dow | 2.5 - | 2.0 | 2.0 - | — | — |
| | | KC8852 | Polybatch | | P2635- | | |
| | | | AB5 | | 08AA | | |
| H3 | 44 | 47.5 - Dow | 2.5 - | 2.0 | 4.0 - | — | — |
| | | KC8852 | Polybatch | | P2635- | | |
| | | | AB5 | | 08AA | | |
| H4 | 44 | 43.5 - Dow | 2.5 - | 2.0 | 8.0 - | — | — |
| | | KC8852 | Polybatch | | P2635- | | |
| | | | AB5 | | 08AA | | |
| H5 | 44 | 49.5 - Dow | 2.5 - | 2.0 | 2.0 - | — | — |
| | | KC8852 | Polybatch | | U0294L | | |
| | | | AB5 | | | | |
| H6 | 34.5 | 60 - Dow | 1.0 - | 2.0 | 2.5 - | — | — |
| | | KC8852 | Ampacet | | XU1515 | | |
| | | | 10919 | | | | |
| H7 | 32 | 60 - Dow | 1.0 - | 2.0 | 5.0 - | — | — |
| | | KC8852 | Ampacet | | XU1515 | | |
| | | | 10919 | | | | |
| H8 | 39.5 | 55 - Exxon | 1.0 - | 2.0 | 2.5 - | — | — |
| | | Exact 8203 | Ampacet | | XU1515 | | |
| | | | 10919 | | | | |
| H9 | 37 | 55 - Exxon | 1.0 - | 2.0 | 5.0 - | — | — |
| | | Exact 8203 | Ampacet | | XU1515 | | |
| | | | 10919 | | | | |
| H10 | 39.5 | 55 - Exxon | 1.0 - | 2.0 | 2.5 - | — | — |
| | | Exact 4151 | Ampacet | | XU1515 | | |
| | | | 10919 | | | | |
| H11 | 37 | 55 - Exxon | 1.0 - | 2.0 | 5.0 - | — | — |
| | | Exact 4151 | Ampacet | | XU1515 | | |
| | | | 10919 | | | | |
| H12 | 30 | 47 - Exxon | 1.0 - | 2.0 | 5.0 - | 15 | — |
| | | Exact 4151 | Ampacet | | XU1515 | | |
| | | | 10919 | | | | |
| H13 | 39.5 | 50 - Exxon | 1.0 - | 2.0 | 2.5 - | — | 5 |
| | | Exact 8203 | Ampacet | | XU1515 | | |
| | | | 10919 | | | | |
| H14 | 30 | 49.5 - Exxon | 1.0 - | 2.0 | 2.5 - | 15 | — |
| | | Exact 8203 | Ampacet | | XU1515 | | |
| | | | 10919 | | | | |
| H15 | 37 | 50 - Exxon | 1.0 - | 2.0 | 5.0 - | — | 5 |
| | | Exact 8203 | Ampacet | | XU1515 | | |
| | | | 10919 | | | | |
| H16 | 27.5 | 49.5 - Exxon | 1.0 - | 2.0 | 5.0 - | 15 | — |
| | | Exact 8203 | Ampacet | | XU1515 | | |
| | | | 10919 | | | | |

¹AT Plastics-Ateva 1231 (EVA copolymer with 12% vinyl acetate)
²Dow Affinity - KC8852 (ethylene-octene copolymer) or Exxon Exact 8203 (ethylene-ocetene copolymer) or Exxon Exact 4151 (ethylene based plastomer)
³A. Schulman Polybatch AB5 (5% amorphous silica in 95% LDPE) or Ampacet 10919 (3% Dynamar process aid in LEDPE)
⁴A. Schulman Polybatch VLA 55 SF (5% antistat in polyethylene)
⁵A. Schulman P2635-08AA (4% endothermic blowing agent in polypropylene) or A. Schulman U0294L (20% endothermic blowing agent in polyethylene) or A. Schulman XU1515 (30% endothermic blowing agent in EMA)
⁶Huntsman H2105 (HDPE with density of 0.963 g/cc)
⁷A. Schulman XABVT-1205 (Tospearl in LDPE)

TABLE 2
CORE LAYER

| | Nucleated | | | | | |
|---|---|---|---|---|---|---|
| | Homo- | Homo- | CaCO₃ in | TiO₂ in | | |
| Example | polypropylene¹ | polypropylene² | polypropylene³ | polypropylene⁴ | PA 609A⁵ | RncoPP⁶ |
| C1 | 40 | 25 | 25 | 10 - Polybatch | — | — |
| | | | | P8555-SD | | |
| C2 | 51 | — | — | — | 34 | 15 |
| C3 | 51 | — | — | 15-Ampacet | 34 | — |
| | | | | 110069 | | |

¹Huntsman P4G4K-173X (nucleated homopolypropylene)
²Huntsman P4G3Z-050 (homopolypropylene)
³A. Schulman Polybatch PF92D (40% CaCO₃ in 60% polypropylene)
⁴A. Schulman Polybatch P8555-SD (50% TiO₂ in polypropylene) or Ampacet 110069 (70% TiO₂ in 30% LLDPE)
⁵Exxon/Mobil Exxalor PA 609A
⁶Huntsman P5M4K-070X (nucleated random copolymer with 3.2% ethylene copolymer)

TABLE 3
SKIN LAYER

| Example | EVA¹ | Homopolypropylene² | MA³ | Antistatic⁴ | Process Aid⁵ | RncoPP⁶ |
|---|---|---|---|---|---|---|
| S1 | 50 | 50-P4G4K-173X | — | — | — | — |
| S2 | 50 | 25-P4G4K-173X | — | — | — | 25 |
| S3 | 50 | — | 47 | 2.0 | 1.0 | — |
| S4 | 50 | 47-P4G3Z-050 | — | 2.0 | 1.0 | — |

¹AT Plastics - Ateva 1821 (EVA copolymer with 18% vinyl acetate)
²Huntsman P4G4K-173X (nucleated homopolypropylene) or Huntsman P4G3Z-050 (homopolypropylene)
³Mitsui Admer QF551A (maleic anhydride)
⁴A. Schulman Polybatch VLA 55 SF (5% antistat in polyethylene)
⁵Ampacet 10919 (3% Dynamar process aid in LDPE)
⁶Huntsman P5M4K-070X (nucleated random copolymer with 3.2% ethylene copolymer)

TABLE 4
TIE LAYER

| | | | | | | Ethylene- | | |
|---|---|---|---|---|---|---|---|---|
| | Nucleated | | | | | octene | | Anti- |
| Example | Homo-PP¹ | Homo-PP² | CaCO₃³ | TiO₂⁴ | PA 609A⁵ | copolymer⁶ | RncoPP⁷ | block⁸ |
| T1 | 40 | 25 | 25 | 10 | — | — | — | — |
| T2 | 51 | — | — | — | 32 | 14-Dow | — | 3.0 |
| | | | | | | KC8852 | | |
| T3 | 56 | — | — | — | 32 | 12-Exxon | — | 0.0 |
| | | | | | | Exact 8203 | | |
| T4 | 51 | — | — | — | 34 | — | 15 | |
| T5 | 51 | — | — | — | 32 | 12-Exxon | — | 5.0 |
| | | | | | | Exact 8203 | | |

¹Huntsman P4G4K-173X (nucleated homopolypropylene)
²Huntsman P4G3Z-050 (homopolypropylene)
³A. Schulman Polybatch PF92D (40% CaCO₃ in 60% polypropylene)
⁴A. Schulman Polybatch P8555-SD (50% TiO₂ in polypropylene)
⁵Exxon/Mobil Exxalor PA 609A
⁶Dow Affinity - KC8852 (ethylene-octene copolymer) or Exxon Exact 8203 (ethylene-octene copolymer)
⁷Huntsman P5M4K-070X (nucleated random copolymer with 3.2% ethylene copolymer)
⁸Ampacet 101964 (slip/antiblock - 3.5% antitstat and 8.6% slip additive)

Multilayered films were then prepared by co-extruding, stretching and annealing the following layers (all percentages being by weight):

TABLE 5
EXAMPLE FILMS

| | Heat Seal | | | | |
|---|---|---|---|---|---|
| Film | Layer | Tie Layer | Core Layer | Tie Layer | Skin Layer |
| 1 | H1 | T1 | C1 | T1 | S1 |
| 2 | H2 | T1 | C1 | T1 | S1 |
| 3 | H2 | T1 | C1 | T1 | S2 |
| 4 | H3 | T1 | C1 | T1 | S2 |
| 5 | H4 | T1 | C1 | T1 | S2 |
| 6 | H5 | T1 | C1 | T1 | S1 |
| 7 | H6 | T2 | C2 | T4 | S3 |
| 8 | H7 | T2 | C2 | T4 | S3 |
| 9 | H8 | T5 | C2 | T4 | S4 |
| 10 | H9 | T5 | C2 | T4 | S4 |
| 11 | H10 | T5 | C2 | T4 | S4 |
| 12 | H11 | T5 | C2 | T4 | S4 |
| 13 | H12 | T5 | C2 | T4 | S4 |
| 14 | H13 | T3 | C3 | T4 | S4 |
| 15 | H14 | T5 | C3 | T4 | S4 |
| 16 | H15 | T3 | C3 | T4 | S4 |
| 17 | H16 | T5 | C3 | T4 | S4 |

The in-mold label films produced above in Table 5, combine the formulations from Tables 1-4, and exhibit the following properties as shown in Table 6 below,

TABLE 6
FILM PROPERTIES

| | | | | Gurley | | |
|---|---|---|---|---|---|---|
| | | | | Stiffness | | |
| In-mold | | Adhesive | Total Film | (normalized | C.O.F. | C.O.F. |
| Label Films | Blowing Agent | Roughness | Density | to 4.25 mil.) | Static | Kinetic |
| 1 | A. Schulman | 3.8 | 0.865 | — | — | — |
| | P2635-08AA | | | | | |
| 2 | A. Schulman | 4.5 | 0.874 | — | — | — |
| | P2635-08AA | | | | | |
| 3 | A. Schulman | 2.2 | 0.873 | — | — | — |
| | P2635-08AA | | | | | |
| 4 | A. Schulman | 8.5 | 0.871 | — | — | — |
| | P2635-08AA | | | | | |
| 5 | A. Schulman | 2.9 | 0.871 | — | — | — |
| | P2635-08AA | | | | | |
| 6 | A. Schulman | 27.9 | 0.843 | — | — | — |
| | U0294L | | | | | |
| 7 | A. Schulman | 0.50 | 0.937 | 79 | 0.426 | 0.645 |
| | XU1515 | | | | | |
| 8 | A. Schulman | 447 | 0.807 | 53 | 1.498 | 1.547 |
| | XU1515 | | | | | |

* Sheffield Roughness

Each of the documents referred to herein is incorporated herein by reference. All numerical quantities used to describe or claim the invention are understood to be modified by the word “about” except in examples and where explicitly indicated otherwise. Range and ratio limits used to define the invention throughout this application, in both the specification and claims, are understood to be combinable.

While the invention has been explained in relation to specific embodiments, various modifications thereof will become apparent to those skilled in the art upon reading this application. It is understood that these various modifications, which fall within the scope of this detailed description and the appended claims, form a part of this invention.

What is claimed is:

1. An in-mold label film comprising a core layer and a heat seal layer, wherein the core layer has a first and second surface and the heat seal layer has an inner surface and an outer surface with the inner surface of the heat seal layer overlying the first surface of the core layer, wherein the heat seal layer comprises a foamed polymer having a rough outer surface.

2. The film of claim 1 wherein the heat seal layer comprises a polymer and a blowing agent.

3. The film of claim 2 wherein the blowing agent comprises a physical blowing agent.

4. The film of claim 2 wherein the blowing agent comprises a chemical blowing agent.

5. The film of claim 2 wherein the blowing agent comprises a combination of a physical blowing agent and a chemical blowing agent.

6. The film of claim 3 wherein the physical blowing agent comprises a compressed gas.

7. The film of claim 3 wherein the physical blowing agent comprises a volatile liquid.

8. The film of claim 3 wherein the physical blowing agent comprises a combination of a compressed gas and a volatile liquid.

9. The film of claim 4 wherein the chemical blowing agent comprises an exothermic blowing agent.

10. The film of claim 4 wherein the chemical blowing agent comprises an endothermic blowing agent.

11. The film of claim 4 wherein the chemical blowing agent comprises a combination of an exothermic blowing agent and an endothermic blowing agent.

12. The film of claim 4 wherein the chemical blowing agent comprises an endothermic blowing agent and a polymer.

13. The film of claim 1 wherein the heat seal layer comprises at least one thermoplastic polymer.

14. The film of claim 13 wherein the heat seal layer comprises polyethylene.

15. The film of claim 1 wherein the core layer and heat seal layer are coextruded, the film is uniaxially or biaxially oriented, and the film is annealed.

16. A labeled plastic article comprising the in-mold label film of claim 1.

17. A process for in-mold labeling, comprising:
providing an in-mold label film comprising a core layer and a heat seal layer, wherein the core layer has a first and second surface and the heat seal layer has an inner surface and an outer surface with the inner surface of the heat seal layer overlying the first surface of the core layer, wherein the heat seal layer comprises a foamed polymer having a rough outer surface;
inserting the film into a mold for producing a plastic article with an inside and outside surface;
positioning and adhering the film to an interior molding surface of the mold by contacting the second surface of the core layer of the film with the internal molding surface of the mold;
forming a labeled plastic article in the mold with sufficient heat to bond the heat seal layer of the film to the outside surface of the plastic article;
cooling the labeled plastic article; and
removing the labeled plastic article from the mold.

18. A labeled plastic article prepared in accordance with the process of claim 17.

19. The article of claim 18 wherein the label is clear.

20. A method to improve the blister and handleability performance of an in-mold label film, comprising:
forming an in-mold label film wherein the film comprises a core layer and a heat seal layer, wherein the core layer has a first and second surface and the heat seal layer has an inner surface and an outer surface with the inner surface of the heat seal layer overlying the first surface of the core layer, wherein the heat seal layer comprises a foamed polymer having a rough outer surface.
